(19) United States
(12) Patent Application Publication
(10) Pub. No.: US 2026/0094366 A1
(43) Pub. Date: Apr. 2, 2026

(54) THREE-DIMENSIONAL RECONSTRUCTION METHOD BASED ON KINEMATIC CALIBRATION OF LINE STRUCTURED LIGHT POINT SET INDIVIDUALIZATION

(71) Applicant: GUANGDONG UNIVERSITY OF TECHNOLOGY, Guangzhou (CN)

(72) Inventors: Jian GAO, Guangzhou (CN); Weibin ZHONG, Guangzhou (CN); Zhuojun ZHENG, Guangzhou (CN); Xin LIU, Guangzhou (CN); Lanyu ZHANG, Guangzhou (CN); Xin CHEN, Guangzhou (CN)

(21) Appl. No.: 19/413,192

(22) Filed: Dec. 9, 2025

Related U.S. Application Data
(63) Continuation of application No. PCT/CN2025/103482, filed on Jun. 25, 2025.

(30) Foreign Application Priority Data
Sep. 24, 2024 (CN) 202411333537.X

(51) Int. Cl. G06T 17/00; G06T 7/80

(52) U.S. Cl. CPC G06T 17/00; G06T 7/80

(57) ABSTRACT

Disclosed is a three-dimensional reconstruction method based on kinematic calibration of line structured light point set individualization, and the method includes the following steps: rigidly assembling an area-array camera and a line structured light emitter, and mounting the assembly on a motion platform; calibrating structural parameters of the motion platform of a measuring device by using a reference radius of a standard sphere and line structured light scanned data; registering a spatial position relationship of a line structured light point set by taking a calibrated spherical center position of the standard sphere and the reference radius of the standard sphere as constraints; controlling the five-axis motion platform to move and acquiring scanned data of a measured member under different poses; and completing high-quality three-dimensional model reconstruction of the measured member subjected to multi-pose scanning by using the scanned data and a real-time point cloud registration matrix.

### CROSS-REFERENCE TO RELATED APPLICATIONS

This application is a continuation of International Patent Application No. PCT/CN2025/103482 with a filing date of Jun. 25, 2025, designating the United States, now pending, and further claims priority to Chinese Patent Application No. 202411333537.X with a filing date of Sep. 24, 2024. The content of the aforementioned applications, including any intervening amendments thereto, are incorporated herein by reference.

### TECHNICAL FIELD

The present invention relates to the field of three-dimensional reconstruction, and particularly a three-dimensional reconstruction method based on kinematic calibration of line structured light point set individualization.

### BACKGROUND OF THE PRESENT INVENTION

With the rapid development of China's manufacturing industry, the requirements for high-precision detection of complex workpieces are increasing day by day. The combination of line structured light and five-axis motion platform can achieve multi-pose scanning and point cloud model reconstruction, thereby completing the detection of complex workpieces. However, due to manufacturing and assembly errors, there is often a certain deviation between an actual structure and a theoretical structure of the five-axis motion platform, which affects a positioning accuracy. Because a reconstruction accuracy of the line structured light is related to the structure of the platform, an accuracy of the platform is improved by kinematic calibration first, then point clouds are obtained by line structured light scanning, and the point clouds are registered in real time, thereby improving a three-dimensional reconstruction accuracy of a line structured light multi-pose scanning system.

Kinematic calibration is a method for compensating a geometric error of the platform and improving an absolute accuracy. Existing kinematic calibration methods usually rely on expensive equipment, such as a laser tracker, to collect multi-axis motion pose information, thereby having high calibration costs, and have the problem of insufficient observation data. In addition, the multi-pose three-dimensional reconstruction accuracy of the line structured light is not only related to the positioning accuracy of the platform, but also influenced by position accuracies of the point clouds. In the existing methods, the real-time registration of the point clouds measured by the line structured light is usually not considered, which leads to insufficient three-dimensional reconstruction accuracy of the line structured light multi-pose scanning system.

### SUMMARY OF THE PRESENT INVENTION

In view of this, in order to solve the difficult problem of three-dimensional reconstruction of existing line structured light multi-pose scanning system, the present invention provides a three-dimensional reconstruction method based on kinematic calibration of line structured light point set individualization, which includes the following steps:
rigidly assembling an area-array camera and a line structured light emitter, and mounting the assembly on a five-axis motion platform to obtain a measuring device,
calibrating structural parameters of the motion platform of the measuring device by using a reference radius of a standard sphere and line structured light scanned data to obtain a calibrated measuring device;
registering a spatial position relationship of a line structured light point set by taking a calibrated spherical center position of the standard sphere and the reference radius of the standard sphere as constraints to obtain a real-time point cloud registration matrix;
controlling the five-axis motion platform to move and acquiring scanned data of the standard sphere under different poses;
automatically completing high-quality three-dimensional model reconstruction of the measured member subjected to multi-pose scanning according to the scanned data and the real-time point cloud registration matrix based on the calibrated measuring device.

Beneficial effects of the embodiment are as follows: by using the assembly of the line structured light emitter and the camera, non-contact three-dimensional vision measurement is achieved without using a laser tracker, which reduces calibration costs; and moreover, because a line structured light three-dimensional scanning system may collect dense point clouds by controlling the platform to move, and all the point clouds may directly participate in the calibration of the structural parameters of the motion platform at the same time, an amount of observation data required for calibration is greatly increased, so that identification accuracies of error parameters are improved.

In addition, if the measuring device has been calibrated, the calibration step is skipped.

In some embodiments, the step of calibrating the structural parameters of the motion platform of the measuring device by using the reference radius of the standard sphere and the line structured light scanned data to obtain the calibrated measuring device, specifically includes:
fixing the standard sphere in a center of a flange at an end-effector of the five-axis motion platform;
controlling the five-axis motion platform to move and acquiring scanned data of the standard sphere under different poses;
constructing a kinematic model and a kinematic error model according to an influence of each axis of the five-axis motion platform on the end-effector, and determining error parameter terms;
calculating a spherical surface arc point cloud in a coordinate system of the end-effector, and taking multiple frames of point clouds for fitting to obtain a spherical center, so as to obtain an initial spherical center position;
constructing an objective function according to three-dimensional information of the spherical surface arc point cloud, the initial spherical center position and the reference radius of the standard sphere; and
based on the objective function, individualizing point sets of all the spherical surface arc point clouds and then allowing the point sets to directly participate in error identification, and completing the calibration of the structural parameters of the motion platform to obtain the calibrated measuring device.

Beneficial effects of the embodiment are as follows: by using influences of the structural parameters of the translation axis and the rotation axis on a measured center and a measured radius of the standard sphere, an interference caused by a calculation error of a light plane of line structured light is minimized, and both of the translation axis and the rotation axis may be calibrated, and meanwhile, the point sets of all the spherical surface arc point clouds scanned may directly participate in the error identification after being individualized, so as to finally ensure accurate identification results of error parameters, thereby improving a motion accuracy of the platform and a reconstruction accuracy of the three-dimensional point cloud model.

In some embodiments, the step of completing the high-quality three-dimensional model reconstruction of the measured member subjected to the multi-pose scanning by using the scanned data and the real-time point cloud registration matrix based on the calibrated measuring device, specifically includes:
calculating three-dimensional information of a center point of a line structured light stripe in a coordinate system of the camera according to an intrinsic matrix of the camera and a light plane equation in the coordinate system of the camera based on the calibrated measuring device; and
transforming the scanned data under each pose to the coordinate system of the end-effector according to the hand-eye transformation matrix, a calibrated kinematic inverse transformation matrix and the real-time point cloud registration matrix.

Beneficial effects of the embodiment are as follows: by using the kinematically calibrated spherical center position of the standard sphere, the spatial position relationship of the line structured light point set may be calibrated, which further improves a detection accuracy of the system. The linear structured light system is matched with the kinematically calibrated multi-axis motion platform, so that a complex workpiece may be scanned in many directions and each frame of point cloud may be transformed into the same coordinate system through a motion relationship, thereby automatically achieving high-quality complete shape reconstruction of a multi-direction scanned point cloud model of the complex workpiece.

The present invention further provides a three-dimensional reconstruction system, which includes:
a device fixing module configured for rigidly assembling an area-array camera and a line structured light emitter, and mounting the assembly on a five-axis motion platform to obtain a measuring device;
a calibrating module configured for calibrating structural parameters of the motion platform of the measuring device by using a reference radius of a standard sphere and line structured light scanned data to obtain a calibrated measuring device;
a point cloud registering module configured for registering a spatial position relationship of a line structured light point set by taking a calibrated spherical center position of the standard sphere and the reference radius of the standard sphere as constraints to obtain a real-time point cloud registration matrix;
a scanning module configured for controlling the five-axis motion platform to move and acquiring scanned data of a measured member under different poses; and
a point cloud reconstructing module configured for automatically completing high-quality three-dimensional model reconstruction of the measured member subjected to multi-pose scanning according to the scanned data and the real-time point cloud registration matrix based on the calibrated measuring device.

Based on the above solution, the present invention provides the three-dimensional reconstruction method based on the kinematic calibration of the line structured light point set individualization, wherein the line structured light is combined with the five-axis platform, and the three-dimensional reconstruction of the overall shape of the measured workpiece is carried out by using the calibrated five-axis platform and the three-dimensional point cloud, thereby improving a reconstruction accuracy of the line structured light multi-pose three-dimensional point cloud model while ensuring a motion accuracy of the platform and an absolute accuracy of the line structured light point set.

### DESCRIPTION OF THE DRAWINGS

FIG. 1 is a flow chart of steps in a three-dimensional reconstruction method based on kinematic calibration of line structured light point set individualization according to the present invention;

FIG. 2 is a schematic diagram of kinematic modeling of a five-axis motion platform in a specific embodiment of the present invention;

FIG. 3 is a schematic diagram of a calculation error of a light plane in the specific embodiment of the present invention; and

FIG. 4 is a structural diagram of a three-dimensional reconstruction system according to the present invention.

### DETAILED DESCRIPTION OF PREFERRED EMBODIMENTS

In addition to the problem that existing calibration methods usually rely on expensive equipment, such as a laser tracker, thereby having high costs in the background, according to a traditional standard sphere calibration method, a spherical center calculated from each point cloud is used for registration to calibrate kinematic parameters, there are fewer parameters capable of participating in identification, and multiple structural parameters of a motion platform cannot be calibrated at the same time, and meanwhile, because the calculation of a spherical center from a single point cloud is easily influenced and interfered by a calculation accuracy of a center point of a stripe, it is difficult to ensure an accurate identification result, thereby further affecting a positioning accuracy of the platform and a reconstruction accuracy of a point cloud model.

Technical solutions in embodiments of the present application are clearly and completely described hereinafter with reference to the drawings in the embodiments of the present application. Apparently, the described embodiments are merely some but not all of the embodiments of the present application. Based on the embodiments of the present application, all other embodiments obtained by those of ordinary skills in the art without going through any creative work shall fall within the scope of protection of the present application.

It should also be noted that, for convenience of description, only parts related to the present invention are shown in the drawings. The embodiments of the present application and features in the embodiments may be combined with each other in the case of no conflict.

It should be understood that “system”, “device” and/or “module” used in the present application is a method for distinguishing different components, elements, units, parts or assemblies at different levels. However, if other terms may achieve the same purpose, this term may be replaced by other expressions.

As shown in the present application and the claims, the terms, such as “a”, “an”, “a kind of” and/or “the”, do not refer to the singular, but may also include the plural unless otherwise specified in the context. Generally, the terms “include” and “contain” only imply the inclusion of clearly marked steps and elements, and these steps and elements do not constitute an exclusive list, and a method or a device may also include other steps or elements. An element limited by “include a/an . . . ” does not exclude other same elements existing in the process, the method, the article, or the device that includes the element.

In the descriptions of the embodiments of the present application, the term “multiple” refers to being two or more. The following terms “first” and “second” are only used for descriptive purposes, but cannot be understood as indicating or implying relative importance, or implicitly indicating the number of indicated technical features. Therefore, the feature defined by “first” and “second” may explicitly or implicitly include one or more of the features.

In addition, a flow chart is used in the present application to explain operations executed by a system according to the embodiments of the present application. It should be understood that the preceding or following operations are not necessarily executed accurately in order. Instead, the steps may be processed in reverse order or simultaneously. Meanwhile, other operations may also be added into these processes, or one or more steps of operations may be removed from these processes.

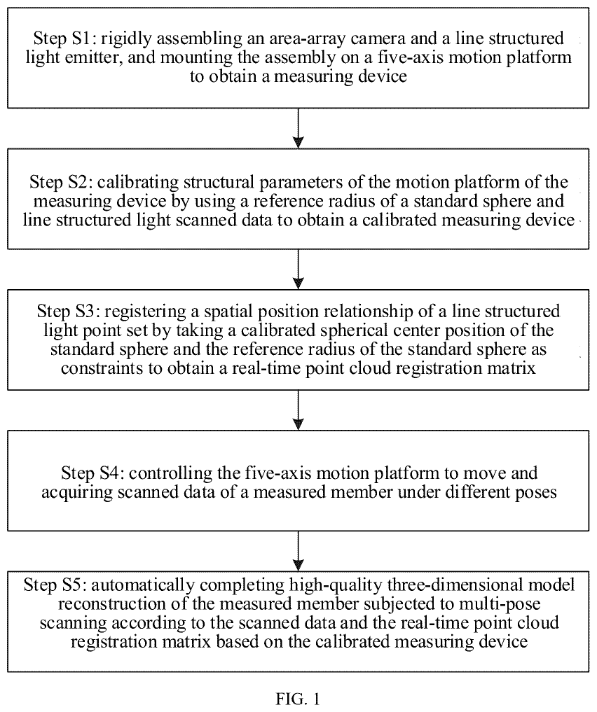

FIG. 1 is a flow chart of an optional example of a three-dimensional reconstruction method based on kinematic calibration of line structured light point set individualization provided by the present invention, and the method may be applied to a computer device. The three-dimensional point cloud reconstruction method provided in the embodiment may include, but be not limited to, the following steps.

In step S1, an area-array camera and a line structured light emitter are rigidly assembled, and mounted on a five-axis motion platform to obtain a measuring device.

After the components are assembled, and a line structured light stripe is within a field of view of the camera.

In step S2, structural parameters of the motion platform of the measuring device are calibrated by using a reference radius of a standard sphere and line structured light scanned data to obtain a calibrated measuring device.

In S2.1, the standard sphere is fixed in a center of a flange at an end-effector of the five-axis motion platform.

In S2.2, the five-axis motion platform is controlled to move and scanned data of the standard sphere under different poses are acquired.

Specifically, in the case of ensuring that the line structured light can irradiate a surface of the standard sphere, the platform moves at will, so as to obtain the scanned data of the standard sphere under each pose.

In S2.3, a kinematic model and a kinematic error model are constructed according to an influence of each axis of the five-axis motion platform on the end-effector, and error parameter terms are determined.

In S2.4, a spherical surface arc point cloud in a coordinate system of the end-effector is calculated, and multiple frames of point clouds are taken for fitting to obtain a spherical center, so as to obtain an initial spherical center position.

In S2.5, an objective function is constructed according to three-dimensional information of the spherical surface arc point cloud, the initial spherical center position and the reference radius of the standard sphere.

In S2.6, based on the objective function, point sets of all the spherical surface arc point clouds are individualized and then directly participate in error identification, and the calibration of the structural parameters of the motion platform is completed to obtain the calibrated measuring device.

In step S3, a spatial position relationship of a line structured light point set is registered by taking a calibrated spherical center position of the standard sphere and the reference radius of the standard sphere as constraints to obtain a real-time point cloud registration matrix.

In step S4, a five-axis motion platform is controlled to move and scanned data of a measured member under different poses are acquired.

In step S5, high-quality three-dimensional model reconstruction of the measured member subjected to multi-pose scanning is automatically completed according to the scanned data and the real-time point cloud registration matrix based on the calibrated measuring device.

In some feasible embodiments, the S2.3 specifically includes the followings.

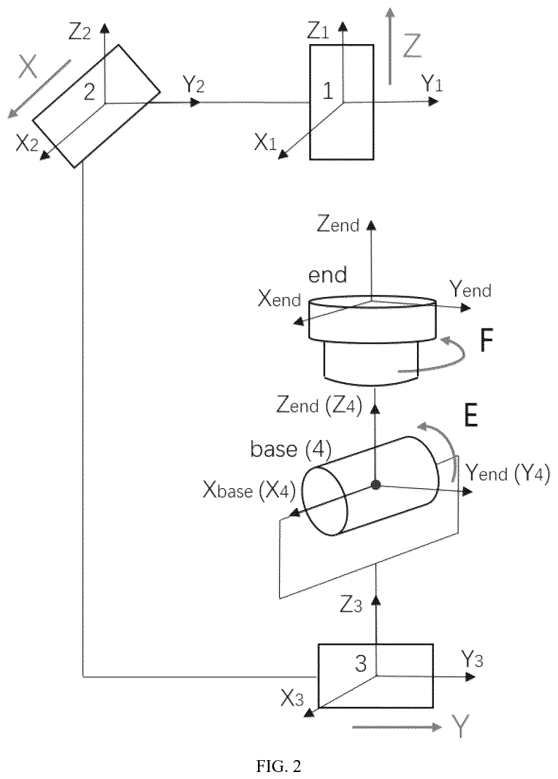

The kinematic model is constructed, and the kinematic modeling refers to FIG. 2.

According to the influence on the end-effector, the five-axis platform may be divided into a translation axis and a rotation axis, and because a translational motion of a machine tool does not affect a rotational motion, the following model is constructed for the translation axis first:

$${}_{3}^{base} M = {}_{1}^{base} {M}_{2}^{1} {M}_{3}^{2} M = [ \begin{matrix}1 & 0 & 0 & {a}_{11} ( {k}_{1} X + x ) + {a}_{12} ( {k}_{2} Y + y ) + {a}_{13} ( {k}_{3} Z + z ) \\ 0 & 1 & 0 & {a}_{21} ( {k}_{1} X + x ) + {a}_{22} ( {k}_{2} Y + y ) + {a}_{23} ( {k}_{3} Z + z ) \\ 0 & 0 & 1 & {a}_{31} ( {k}_{1} X + x ) + {a}_{32} ( {k}_{2} Y + y ) + {a}_{33} ( {k}_{3} Z + z ) \\ 0 & 0 & 0 & 1\end{matrix} ]$$

wherein, a₁₁, a₁₂, a₁₃, a₂₁, a₂₂, a₂₃, a₃₁, a₃₂ and a₃₃ are nine parameters related to a yaw coefficient, and the yaw coefficient describes a yaw degree of each translation axis; k₁, k₂ and k₃ are three parameters related to a pulse motion ratio, and the pulse motion ratio describes a ratio of a unit pulse motion amount of encoder feedback and a value of machine vision measurement; X, Y and Z are encoder feedback amounts, and the encoder feedback amount describes a motion amount of the end-effector along each axis direction; and x, y and z are three parameters related to an initial deviation, and the initial deviation describes a deviation between an origin of a base coordinate system established by a hand-eye relationship and an actually selected origin of the machine tool in X, Y and Z directions. By taking the five-axis motion platform mentioned herein as an example, an intersection of an A axis and a C axis is selected as the origin of the machine tool.

The above formula is simplified to obtain the following formula:

$${}_{3}^{base} M = {}_{1}^{base} {M}_{2}^{1} M {}_{3}^{2} M = [ \begin{matrix}1 & 0 & 0 & {b}_{11} X + {b}_{12} Y + {b}_{13} Z + {d}_{1} \\ 0 & 1 & 0 & {b}_{21} X + {b}_{22} Y + {b}_{23} Z + {d}_{2} \\ 0 & 0 & 1 & {b}_{31} X + {b}_{32} Y + {b}_{33} Z + {d}_{3} \\ 0 & 0 & 0 & 1\end{matrix} ]$$

The following model is constructed for a transformational relationship between the translation axis and the rotation axis:

$${}_{4}^{3} M = [ \begin{matrix}1 & 0 & 0 & 0 \\ 0 & cos ( A + a ) & - sin ( A + a ) & 0 \\ 0 & sin ( A + a ) & cos ( A + a ) & 0 \\ 0 & 0 & 0 & 1\end{matrix} ] [ \begin{matrix}cos γ & 0 & sin γ & 0 \\ 0 & 1 & 0 & 0 \\ - sin γ & 0 & cos γ & 0 \\ 0 & 0 & 0 & 1\end{matrix} ] [ \begin{matrix}cos θ & - s in θ & 0 & 0 \\ sin θ & cos θ & 0 & 0 \\ 0 & 0 & 1 & 0 \\ 0 & 0 & 0 & 1\end{matrix} ]$$

wherein, A is an encoder feedback amount of rotation around an X-axis direction, a is an initial deviation of rotation around the X-axis direction, and γ and θ are two rotational degrees of freedom required in transformation of a translation axis coordinate system and a rotation axis coordinate system.

The following model is constructed for the transformational relationship between the translation axis and the rotation axis:

$${}_{end}^{4} M = [ \begin{matrix}cos ( C + c ) & - sin ( C + c ) & 0 & 0 \\ sin ( C + c ) & cos ( C + c ) & 0 & 0 \\ 0 & 0 & 1 & {d}_{4} \\ 0 & 0 & 0 & 1\end{matrix} ]$$

wherein, C is an encoder feedback amount of rotation around a Z-axis direction, c is an initial deviation of rotation around the Z-axis direction, and d₄ is a length of a connecting rod between the rotation axes.

Finally, the kinematic model may be obtained by the above formula:

$${}_{end}^{base} M = {}_{3}^{base} M {}_{4}^{3} M {}_{end}^{4} M$$

The kinematic error model is constructed.

All the structural parameters, excluding X, Y, Z, A and C, of the motion platform in the above kinematic model are fixed values, which are theoretical values determined by a three-dimensional model of the platform. Because of inevitable introduction of error during manufacturing and assembly of the platform, there may be errors in all these theoretical values, so that a result calculated from the structural parameters of the motion platform deviates from an actual motion result. Therefore, it is necessary to construct the kinematic error model of the five-axis motion platform and calibrate the structural parameters of the motion platform with error terms. Then, error models

$${}_{3}^{base} M , {}_{4}^{3} M and {}_{end}^{4} M$$

are respectively determined as follows:

$$\begin{matrix}{}_{3}^{base} M = [ \begin{matrix}1 & 0 & 0 & ( {b}_{11} + Δ {b}_{11} ) X + ( {b}_{12} + Δ {b}_{12} ) Y + ( {b}_{13} + Δ {b}_{13} ) Z + {d}_{1} + Δ {d}_{1} \\ 0 & 1 & 0 & ( {b}_{21} + Δ {b}_{21} ) X + ( {b}_{22} + Δ {b}_{22} ) Y + ( {b}_{23} + Δ {b}_{23} ) Z + {d}_{2} + Δ {d}_{2} \\ 0 & 0 & 1 & ( {b}_{31} + Δ {b}_{31} ) X + ( {b}_{32} + Δ {b}_{32} ) Y + ( {b}_{33} + Δ {b}_{33} ) Z + {d}_{3} + Δ {d}_{3} \\ 0 & 0 & 0 & 1\end{matrix} ] \\ {}_{4}^{3} M = [ \begin{matrix}1 & 0 & 0 & 0 \\ 0 & cos ( A + a + Δ a ) & - sin ( A + a + Δ a ) & 0 \\ 0 & sin ( A + a + Δ a ) & cos ( A + a + Δ a ) & 0 \\ 0 & 0 & 0 & 1\end{matrix} ] \\ [ \begin{matrix}cos ( γ + Δ γ ) & 0 & sin ( γ + Δ γ ) & 0 \\ 0 & 1 & 0 & 0 \\ - sin ( γ + Δ γ ) & 0 & cos ( γ + Δ γ ) & 0 \\ 0 & 0 & 0 & 1\end{matrix} ] [ \begin{matrix}cos ( θ + Δ θ ) & - sin ( θ + Δ θ ) & 0 & 0 \\ sin ( θ + Δ θ ) & cos ( θ + Δ θ ) & 0 & 0 \\ 0 & 0 & 1 & 0 \\ 0 & 0 & 0 & 1\end{matrix} ] \\ {}_{end}^{4} M = [ \begin{matrix}cos ( C + c + Δ c ) & - sin ( C + c + Δ c ) & 0 & 0 \\ sin ( C + c + Δ c ) & cos ( C + c + Δ c ) & 0 & 0 \\ 0 & 0 & 1 & {d}_{4} + Δ {d}_{4} \\ 0 & 0 & 0 & 1\end{matrix} ]\end{matrix}$$

It can be seen from the above formula that the kinematic error model contains 17 error terms.

In some feasible embodiments, in the S2.4 and the S2.5:
a center point P_{camera} of a line structured light stripe in a coordinate system of the camera is calculated according to an intrinsic matrix of the camera and a light plane equation in the coordinate system of the camera first, and then a three-dimensional point cloud is transformed to the coordinate system of the end-effector of the platform according to a hand-eye transformation matrix

$${}_{camera}^{base} M$$

and the kinematic model

$${}_{camera}^{base} M$$

to obtain the spherical surface arc point cloud P_{end} in the coordinate system of the end-effector, by a transformation formula as follows:

$${P}_{end} {=}_{camera}^{base} {M}^{- 1} {P}_{camera} = {}_{base}^{end} M {P}_{camera}$$

wherein the intrinsic matrix of the camera and the light plane equation in the coordinate system of the camera are respectively obtained by camera calibration and light plane calibration, both of which are implemented by mature methods, which will not be repeated herein. It should be stressed that the hand-eye transformation matrix is obtained by orthogonal hand-eye calibration after fitting a motion direction of each axis, and no kinematic parameter error is introduced. In addition, because actual structural parameter information of the motion platform is not referred during the light plane calibration, there is inevitably a calculation error of a light plane, which will affect a calculation accuracy of a single frame of line structured light point cloud, so that it is necessary to compensate the error introduced by insufficient calculation accuracy of the light plane after subsequent calibration of the structural parameters of the motion platform, thereby ensuring a quality of the line structured light three-dimensional reconstruction model.

The multiple frames of non-collinear point clouds are taken for data calculation to obtain the spherical center Q_{center}, and a position of the spherical center is used as the initial position, which is also described by the coordinate system of the end-effector. The objective function is constructed by using a difference between a distance from the spherical surface arc point cloud P_{end} to the initial spherical center Q_{center} in the coordinate system of the end-effector and the reference radius r of the standard sphere as follows:

$$Δ r = {‖ {P}_{end} - {Q}_{center} ‖}^{2} - {r}^{2}$$

In some feasible embodiments, in the S2.6:
a physical significance of error parameter identification is to minimize an error between a model output and actual observation data by adjusting the error terms. Aiming at the objective function provided herein, the data of multiple frame of non-collinear three-dimensional point clouds scanned by the line structured light system are transformed to the coordinate system of the end-effector of the platform according to the encoder feedback amount of each axis and the initial structural parameters of the motion platform first to obtain a theoretical value of the spherical surface arc point cloud in the coordinate system of the end-effector:

$${P}_{end}^{th} {=}_{camera}^{base} {M}^{th} {}_{camera}^{end} M {P}_{camera}$$

The spherical center

$${Q}_{center}^{me}$$

is calculated by using the above theoretical value, and the position of the spherical center may contain error amounts Δx, Δy and Δz in the X, Y and Z directions when being used as the initial position.

Then, all the three-dimensional point clouds scanned by the line structured light system are transformed to the coordinate system of the end-effector of the platform according to the encoder feedback amount of each axis and the structural parameters of the motion platform with the error amounts to obtain a measured value of the spherical surface arc point cloud in the coordinate system of the end-effector:

$${P}_{end}^{me} {=}_{base}^{end} {M}^{me} {}_{camera}^{end} M {P}_{camera}$$

Because the spherical surface arc point clouds are distributed on a spherical surface, all of which are constrained by the radius and center of the standard sphere, all observation data may be subjected to point set individualization and then directly participate in identification, wherein the point set individualization is expressed as follows:

$${P}_{end} ∈ {P}_{end}^{me} ∩ \{ r - ε \leq {‖ p - q - {q}_{center} ‖}_{2} \leq r + ε \}$$

wherein ρ represents a single point, P represents a point set, and q_{center} represents an initial spherical center point determined by multiple frames of line structured light point clouds, so that p_{end} represents a point of line structured light scanned data calculated to the coordinate system of the end-effector,

$${P}_{end}^{me}$$

represents a point set of all measured values obtained by line structured light scanning, and ε is a negligible amount.

Meanwhile, due to the existence of the A axis and the C axis in the five-axis motion platform, under influences of the axes, when the center of the standard sphere is calculated by using scanned point clouds under multiple poses together, an interference caused by the calculation accuracy of the line structured light three-dimensional point cloud can be reduced as much as possible, thereby ensuring effectiveness of identification, and avoiding the problem that the calculation of the spherical center from each point cloud deviates from an actual result when the calculation accuracy of the single frame of line structured light three-dimensional point cloud is insufficient, which leads to a difficulty in accurately identifying each error parameter. The point set

$${P}_{end}^{me}$$

of the measured values is individualized and then substituted into the objective function together with a unique element

$${q}_{center}^{me}$$

of an initial spherical center point set

$${Q}_{center}^{me} ,$$

and transformed into a matrix form as follows:

$$[ \begin{matrix}Δ {r}_{1} \\ ⋮ \\ Δ {r}_{i} \\ ⋮ \\ Δ {r}_{N}\end{matrix} ] = [ \begin{matrix}{‖ {P}_{end} ( 1 ) - {q}_{center}^{me} ‖}^{2} - {r}^{2} \\ ⋮ \\ {‖ {P}_{end} ( i ) - {q}_{center}^{me} ‖}^{2} - {r}^{2} \\ ⋮ \\ {‖ {P}_{end} ( N ) - {q}_{center}^{me} ‖}^{2} - {r}^{2}\end{matrix} ] = [ \begin{matrix}{J}_{k} ( 1 ) \\ ⋮ \\ {J}_{k} ( i ) \\ ⋮ \\ {J}_{k} ( N )\end{matrix} ] Δ q$$

wherein N is a size of the point set, Jₖ is an error matrix, which is calculated according to all the observation data, and Δq is an error parameter vector to be calculated, which includes 3 parameters carried by the initial spherical center and 17 parameters included in the structural parameters of the motion platform with the error amounts, in a total of 20 error parameters. These 20 error parameters may be identified through an identification algorithm by using influences of an initial spherical center error and a structural parameter error of each motion platform on the measured center and radius of the standard sphere, so as to complete kinematic calibration.

In some feasible embodiments, the step S3 specifically includes the followings.

Because there are two rotation axes including the A axis and the C axis in the five-axis motion platform, the spherical center position of the standard sphere obtained by jointly fitting the spherical surface arc point clouds under each pose is not easily affected by the calculation accuracy of the line structured light three-dimensional point cloud, so that the spherical center position of the standard sphere after kinematic calibration may be used as an ideal spherical center

$${Q}_{center}^{th} .$$

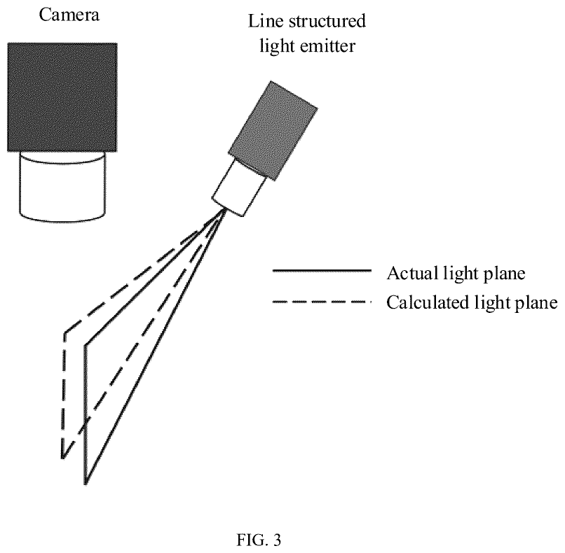

Meanwhile, because the calculation accuracy of the line structured light three-dimensional point cloud is mainly affected by the calculation accuracy of the light plane, when the light plane equation obtained by the light plane calibration does not completely coincide with an actual light plane, the calculation of the line structured light three-dimensional point cloud may have a positional deviation in the X, Y and Z directions, and the positional deviation may be compensated by a diagonal matrix with the error terms after calibration. A schematic diagram of the deviation refers to FIG. 3. Therefore, in the present invention, the ideal spherical center position and the reference radius r of the standard sphere are used as constraints to calibrate the spatial position relationship of the line structured light point set, thereby improving the reconstruction accuracy of the three-dimensional point cloud model. The objective function used for calibration is as follows:

$$Δ r = {‖ {P}_{sphere}^{m e} - {Q}_{center}^{t h} ‖}^{2} - {r}^{2}$$

wherein

$${Q}_{c e n t e r}^{t h}$$

is the spherical center position of the standard sphere after kinematic calibration, which is an ideal spherical center position, and

$${P}_{s p h e r e}^{m e}$$

is the measured value of the spherical surface arc three-dimensional point cloud in the coordinate system of the end-effector, which consists of the initial values x, y and z of point cloud coordinates and a diagonal matrix

$${}_{origin}^{improve} M$$

of position registration, wherein elements on a diagonal of the diagonal matrix are positional error coefficient terms s1, s2 and s3, which means that an error model of

$${P}_{s p h e r e}^{m e}$$

may be constructed as follows:

$${P}_{s p h e r e}^{m e} = [ \begin{matrix}{s}_{1} + Δ {s}_{1} & 0 & 0 \\ 0 & {s}_{2} + Δ {s}_{2} & 0 \\ 0 & 0 & {s}_{3} + Δ {s}_{3}\end{matrix} ] [ \begin{matrix}x \\ y \\ z\end{matrix} ]$$

These three error parameters are identified through the identification algorithm to obtain areal-time point cloud position registration matrix

$${}_{origin}^{improve} {M}^{′} ,$$

which can further improve the absolute accuracy of the line structured light point set and the reconstruction accuracy of the three-dimensional point cloud model.

In some feasible embodiments, the step S5 specifically includes the followings.

After the kinematic calibration and the point cloud position registration above are completed, the motion accuracy of the platform and the absolute accuracy of the line structured light point set are both guaranteed. Therefore, the scanned data of the measured member under different poses are acquired by controlling each axis in the five-axis platform to move, the three-dimensional information of the center point

$${P}_{object}^{c a m e r a}$$

of the line structured light stripe in the coordinate system of the camera is calculated by using the intrinsic matrix of the camera and the light plane equation in the coordinate system of the camera, and scanned point clouds under each pose are transformed to the coordinate system of the end-effector through the hand-eye transformation matrix

$${}_{camera}^{base} M ,$$

the kinematic inverse transformation matrix

$${}_{end}^{base} {M}^{′}$$

after kinematic calibration and the position registration matrix

$${}_{origin}^{improve} {M}^{′}$$

after point cloud position registration to obtain a high-precision three-dimensional point cloud

$${P}_{object}^{e n d}$$

conforming to the shape of the measured workpiece.

$${P}_{object}^{end} = {}_{origin}^{improve} {M}^{′} {}_{end}^{base} {M}^{′} {}_{camera}^{base} {MP}_{object}^{c a m e r a}$$

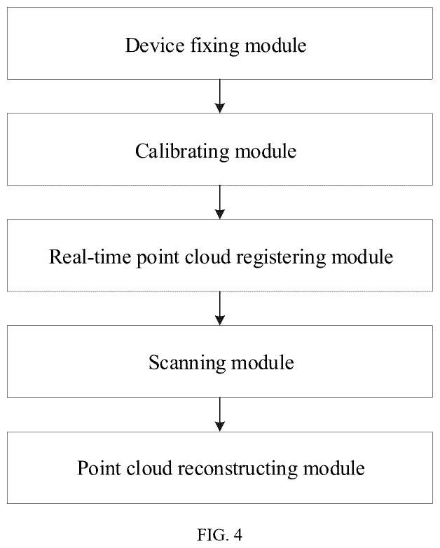

As shown in FIG. 4, a three-dimensional reconstruction system includes:
a device fixing module configured for rigidly assembling an area-array camera and a line structured light emitter, and mounting the assembly on a five-axis motion platform to obtain a measuring device;
a calibrating module configured for calibrating structural parameters of the motion platform of the measuring device by using a reference radius of a standard sphere and line structured light scanned data to obtain a calibrated measuring device;
a point cloud registering module configured for registering a spatial position relationship of a line structured light point set by taking a calibrated spherical center position of the standard sphere and the reference radius of the standard sphere as constraints to obtain a real-time point cloud registration matrix;
a scanning module configured for controlling the five-axis motion platform to move and acquiring scanned data of a measured member under different poses; and
a point cloud reconstructing module configured for automatically completing high-quality three-dimensional model reconstruction of the measured member subjected to multi-pose scanning according to the scanned data and the real-time point cloud registration matrix based on the calibrated measuring device.

All the contents in the above method embodiments are applicable to the system embodiments, the specific functions specifically realized by the system embodiments are the same as those realized by the above method embodiments, and the beneficial effects achieved by the system embodiments are the same as those achieved by the above method embodiments.

A three-dimensional reconstruction device based on kinematic calibration of line structured light point set individualization includes:
at least one processor; and
at least one storage for storing at least one program;
when the at least one program is executed by the at least one processor, the at least one processor implements the three-dimensional reconstruction method based on the kinematic calibration of the line structured light point set individualization above.

All the contents in the above method embodiments are applicable to the device embodiments, the functions specifically achieved by the device embodiments are the same as those achieved by the above method embodiments, and the beneficial effects achieved by the device embodiments are the same as those achieved by the above method embodiments.

A storage medium stores an instruction executable by a processor, wherein the instruction executable by the processor, when executed by the processor, is used for implementing the three-dimensional reconstruction method based on the kinematic calibration of the line structured light point set individualization above.

All the contents in the above method embodiments are applicable to the storage medium embodiments, the functions specifically achieved by the storage medium embodiments are the same as those achieved by the above method embodiments, and the beneficial effects achieved by the storage medium embodiments are the same as those achieved by the above method embodiments.

The foregoing describes the preferred embodiments of the present invention in detail, but the present invention is not limited to the embodiments. Those skilled in the art may further make various equivalent modifications or substitutions without violating the spirit of the present invention, and these equivalent modifications or substitutions are all included in the scope defined by the claims of the present application.

We claim:

1. A three-dimensional reconstruction method based on kinematic calibration of line structured light point set individualization, comprising the following steps:
rigidly assembling an area-array camera and a line structured light emitter, and mounting the assembly on a five-axis motion platform to obtain a measuring device,
wherein, five axes of the five-axis motion platform comprise an X axis, a Y axis, a Z axis, a rotation axis rotating around an X-axis direction and a rotation axis rotating around a Y-axis direction;
calibrating structural parameters of the motion platform of the measuring device by using a reference radius of a standard sphere and line structured light scanned data to obtain a calibrated measuring device;
registering a spatial position relationship of a line structured light point set by taking a calibrated spherical center position of the standard sphere and the reference radius of the standard sphere as constraints to obtain a real-time point cloud registration matrix;
controlling the five-axis motion platform to move and acquiring scanned data of a measured member under different poses; and
completing high-quality three-dimensional model reconstruction of the measured member subjected to multi-pose scanning by using the scanned data and the real-time point cloud registration matrix based on the calibrated measuring device.

2. The three-dimensional reconstruction method based on the kinematic calibration of the line structured light point set individualization according to claim 1, wherein, the step of calibrating the structural parameters of the motion platform of the measuring device by using the reference radius of the standard sphere and the line structured light scanned data to obtain the calibrated measuring device, specifically comprises:
fixing the standard sphere in a center of a flange at an end-effector of the five-axis motion platform;
controlling the five-axis motion platform to move and acquiring scanned data of the standard sphere under different poses;
constructing a kinematic model and a kinematic error model according to an influence of each axis of the five-axis motion platform on the end-effector, and determining error parameter terms;
calculating a spherical surface arc point cloud in a coordinate system of the end-effector, and taking multiple frames of point clouds for fitting to obtain a spherical center, so as to obtain an initial spherical center position;
constructing an objective function according to three-dimensional information of the spherical surface arc point cloud, the initial spherical center position and the reference radius of the standard sphere; and
based on the objective function, individualizing point sets of all the spherical surface arc point clouds and then allowing the point sets to directly participate in error identification, and completing the calibration of the structural parameters of the motion platform to obtain the calibrated measuring device.

3. The three-dimensional reconstruction method based on the kinematic calibration of the line structured light point set individualization according to claim 2, wherein the kinematic model is expressed as follows:
$${}_{end}^{base} M = {}_{3}^{base} M {}_{4}^{3} M {}_{end}^{4} M$$
$${}_{3}^{base} M = {}_{1}^{base} M {}_{2}^{1} M {}_{3}^{2} M [ \begin{matrix}1 & 0 & 0 & {b}_{11} X + {b}_{12} Y + {b}_{13} Z + {d}_{1} \\ 0 & 1 & 0 & {b}_{21} X + {b}_{22} Y + {b}_{23} Z + {d}_{2} \\ 0 & 0 & 1 & {b}_{31} X + {b}_{32} Y + {b}_{33} Z + {d}_{3} \\ 0 & 0 & 0 & 1\end{matrix} ]$$
$${}_{4}^{3} M = [ \begin{matrix}1 & 0 & 0 & 0 \\ 0 & cos ( A + a ) & - sin ( A + a ) & 0 \\ 0 & sin ( A + a ) & cos ( A + a ) & 0 \\ 0 & 0 & 0 & 1\end{matrix} ] [ \begin{matrix}cos γ & 0 & sin γ & 0 \\ 0 & 1 & 0 & 0 \\ - sin γ & 0 & cos γ & 0 \\ 0 & 0 & 0 & 1\end{matrix} ] [ \begin{matrix}cos θ & - sin θ & 0 & 0 \\ sin θ & cos θ & 0 & 0 \\ 0 & 0 & 1 & 0 \\ 0 & 0 & 0 & 1\end{matrix} ]$$
$${}_{end}^{4} M = [ \begin{matrix}cos ( C + c ) & - sin ( C + c ) & 0 & 0 \\ sin ( C + c ) & cos ( C + c ) & 0 & 0 \\ 0 & 0 & 1 & {d}_{4} \\ 0 & 0 & 0 & 1\end{matrix} ]$$
wherein,
$${}_{end}^{base} M$$
represents an overall kinematic model,
$${}_{3}^{base} M$$
represents a translation axis model,
$${}_{4}^{3} M$$
represents a transformational relationship model between a translation axis and the rotation axis,
$${}_{end}^{4} M$$
represents a transformational relationship model between the rotation axes, A is an encoder feedback amount of rotation around the X-axis direction, a is an initial deviation of rotation around the X-axis direction, γ and θ are two rotational degrees of freedom required in transformation of a translation axis coordinate system and a rotation axis coordinate system, C is an encoder feedback amount of rotation around a Z-axis direction, c is an initial deviation of rotation around the Z-axis direction, d₄ is a length of a connecting rod between the rotation axes; b₁₁, b₁₂ and b₁₃ are three proportionality coefficients related to a yaw coefficient and a pulse motion ratio of the X axis, b₂₁, b₂₂ and b₂₃ are three proportionality coefficients related to a yaw coefficient and a pulse motion ratio of the Y axis, b₃₁, b₃₂ and b₃₃ are three proportionality coefficients related to a yaw coefficient and a pulse motion ratio of the Z axis; d₁, d₂ and d₃ are respectively origin deviations in the X-axis, Y-axis and Z-axis directions; and X, Y and Z represent encoder feedback amounts of corresponding axes.

4. The three-dimensional reconstruction method based on the kinematic calibration of the line structured light point set individualization according to claim 2, wherein the objective function is expressed as follows:
$$Δ r = {‖ {P}_{end} - {Q}_{c e n t e r} ‖}^{2} - {r}^{2}$$
wherein, Q_{center} represents the initial spherical center fitted, P_{end} represents the spherical surface arc point cloud in the coordinate system of the end-effector, and r represents the reference radius of the standard sphere.

5. The three-dimensional reconstruction method based on the kinematic calibration of the line structured light point set individualization according to claim 4, wherein a transformation formula of the spherical surface arc point cloud in the coordinate system of the end-effector is as follows:
$${P}_{end} = {}_{end}^{base} M {}_{camera}^{base} {MP}_{camera}$$
wherein,
$${}_{camera}^{base} M$$
represents a hand-eye transformation matrix, and P_{camera} represents a center point of a line structured light stripe in a coordinate system of the camera.

6. The three-dimensional reconstruction method based on the kinematic calibration of the line structured light point set individualization according to claim 2, wherein the multiple frames of non-collinear spherical surface arc point clouds are taken for data fitting to obtain the spherical center.

7. The three-dimensional reconstruction method based on the kinematic calibration of the line structured light point set individualization according to claim 2, wherein the step of completing the high-quality three-dimensional model reconstruction of the measured member subjected to the multi-pose scanning by using the scanned data and the real-time point cloud registration matrix based on the calibrated measuring device, specifically comprises:
calculating three-dimensional information of a center point of a line structured light stripe in a coordinate system of the camera according to an intrinsic matrix of the camera and a light plane equation in the coordinate system of the camera based on the calibrated measuring device; and
transforming the scanned data of the measured member under different poses to the coordinate system of the end-effector according to the hand-eye transformation matrix, a calibrated kinematic inverse transformation matrix and the real-time point cloud registration matrix, and automatically completing the high-quality three-dimensional model reconstruction of the measured member subjected to multi-pose scanning.

8. A three-dimensional reconstruction system used for executing the three-dimensional reconstruction method based on the kinematic calibration of the line structured light point set individualization according to claim 1, comprising:
a device fixing module configured for rigidly assembling an area-array camera and a line structured light emitter, and mounting the assembly on a five-axis motion platform to obtain a measuring device;
a calibrating module configured for calibrating structural parameters of the motion platform of the measuring device by using a reference radius of a standard sphere and line structured light scanned data to obtain a calibrated measuring device;
a real-time point cloud registering module configured for registering a spatial position relationship of a line structured light point set by taking a calibrated spherical center position of the standard sphere and the reference radius of the standard sphere as constraints to obtain a real-time point cloud registration matrix;
a scanning module configured for controlling the five-axis motion platform to move and acquiring scanned data of a measured member under different poses; and
a point cloud reconstructing module configured for completing high-quality three-dimensional model reconstruction of the measured member subjected to multi-pose scanning according to the scanned data and the real-time point cloud registration matrix based on the calibrated measuring device.
